(19) United States
(12) Patent Application Publication
(10) Pub. No.: US 2007/0259569 A1
(43) Pub. Date: Nov. 8, 2007

(54) Device and Method for Generating Predetermined Signal Patterns

(75) Inventors: Xiang-Siong Wang, Hsinchu (TW); Yi-Cheng Lee, Hsinchu (TW); Sheng-Yen Ho, Hsinchu (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: LITE-ON IT CORPORATION, Taipei City (TW)

(21) Appl. No.: 11/532,151

(22) Filed: Sep. 15, 2006

(30) Foreign Application Priority Data
Apr. 7, 2006 (TW) 95112426

(51) Int. Cl. H01R 33/00

(52) U.S. Cl. 439/638

(57) ABSTRACT

A device and a method for generating predetermined signal patterns is disclosed. In the method, a data storage device is operated in a testing mode. Then a function key is utilized to select a signal pattern compliance with an industrial standard of transmission interface. After the transmission of the selected signal pattern, the storage device can be set to leave the testing mode.

### BACKGROUND OF THE INVENTION

1. Field of the Invention

The invention relates in general to the generating of predetermined signal patterns, and more particularly to a device and a method for generating predetermined signal patterns compliance with an industrial standard of transmission interface.

2. Description of the Related Art

To ensure that every data storage device can have a stable performance in data transmission according to an industrial standard of transmission interface, the industrial standard it follows usually has come along with regulations for testing rules and testing procedures. By transmitting or receiving certain predetermined signal patterns according to the industrial standard, the design of a data storage device can be verified before its mass production.

For example, the Serial Advanced Technology bus Attachment Interface (SATA Interface) has started to replace the Parallel Advanced Technology bus Attachment Interface (PATA Interface) as the data transmitting interface for next generation. Comparing with PATA Interface, SATA Interface is designed to support a better heat dissipation inside a housing of a computer system and have a higher data rate with a more reliable signal quality. SATA interface defines seven signal paths for signal transmission including a pair of data transmission lines (Tx+ and Tx−), a pair of data receiving lines (Rx+ and Rx−), and three ground lines (GND). Each pair of transmitting or receiving lines is configured in a form of differential signal pair. Therefore SATA signal travels thereon can have a better capability in noise resisting and allow STAT interface to reach a higher date rate with lower working voltages.

As defined in the industrial standard of SATA interface, each of the signal lines conveys information up to 150 MB/s with working voltage as low as to 0.25V. Therefore it is necessary to verify whether a storage device is fully compliance with the industrial standard of SATA to ensure its reliability and compatibility by testing and measuring with various kinds of predetermined signal patterns. In the industrial standard of SATA, it further defines some self-testing method and procedures such as “Built-In Self-Test The Far-End Transmit Mode” (BIST T Mode) to transmit a selected signal pattern and “Built-In Self-Test The Far-End Retimed Loopback Mode” (BIST L Mode) to transmit a signal pattern responsively to a received signal pattern.

Refer to FIG. 1, which is a block diagram illustrating the configuring of self-testing settings of an SATA device by utilizing a host computer in the prior art. Conventionally, when an SATA device 106 is to be examined under a built-in self-testing mode, the SATA device 106 has to be connected to a host computer 102 first. By executing an SATA Tool Kit program 104 in the host computer 102, the self-test then can be configured, and the signal pattern to be transmitted by the SATA device 106 can be selected. Refer to FIGS. 2A and 2B, which are block diagrams illustrating the testing of SATA devices supporting BIST T Mode and BIST L Mode, respectively. As shown in FIG. 2A, to exam an STAT device 204 supporting BIST T Mode, first the signal pattern to be sent by the SATA device 204 is configured by the host computer 102 and the SATA Tool Kit program 104. Then remove the SATA device from the host computer 102 to an oscilloscope 202 for the monitoring of the transmitted signal pattern. As shown in FIG. 2B, to exam an STAT device 206 supporting BIST L Mode, the signal pattern to be sent by the SATA device 204 has also to be configured by the host computer 102 and the SATA Tool Kit program 104 before it is connected to the oscilloscope 202 for the monitoring of the transmitted signal pattern. Moreover, the SATA device 206 is further connected to an STAT device 204 supporting BIST T Mode for transmitting a predetermined signal pattern to the SATA device 206 to trigger the loop-back operation.

However, there are numbers of different signal patterns for self-testing defined in the SATA industrial standard including: PRBS for simulating the actual communication by random signals, K28.5 for the testing of signal alignment, HFTP for simulating high frequency worst-case signal, and Cominit and ComWake as confirmation signal patterns between STAT host and SATA device, et al. For testing an SATA device with all the signal patterns, the procedure depicted in FIG. 1 and FIG. 2 has to be repeated for each signal pattern. It could bring a lot of inconveniency and wasting of time.

### SUMMARY OF THE INVENTION

It is therefore an object of the invention to provide a device for generating predetermined signal patterns compliance with an industrial standard of transmission interface. The device has a processor, an interface controller electrically connected to the processor, a function key electrically coupled to the processor to control the device to selectively operate in a testing mode, and an interface connector electrically connected to the interface controller for the processor to output a selected signal pattern when the device is in the testing mode.

In an embodiment, the interface controller is compliance with a Parallel Advanced Technology bus Attachment Interface industrial standard, and the interface connector is compliance with the Parallel Advanced Technology bus Attachment Interface industrial standard.

In an embodiment, the interface controller is compliance with a Serial Advanced Technology bus Attachment Interface industrial standard, and the interface connector is compliance with the Serial Advanced Technology bus Attachment Interface industrial standard. And the device supports a “Built-In Self-Test The Far-End Retimed Loopback Mode” (BIST L Mode) and/or a “Built-In Self-Test The Far-End Transmit Mode” (BIST T Mode).

In an embodiment, the function key is a key, a switch, or at least one connecting pin that can be connected to a switch. If the device is an optical disc drive, the function key can be integrated with ejection key of the optical disc drive.

It is another object of the invention to provide a method for generating predetermined signal patterns compliance with an industrial standard of transmission interface. The method has steps of: entering a testing mode; selecting a signal pattern compliance with an industrial standard of transmission interface by a function key; transmitting the selected signal pattern; and ending the testing mode.

In an embodiment, the industrial standard of transmission interface is a Serial Advanced Technology bus Attachment Interface industrial standard. The method can further includes steps of: detecting the repeating times that the function key is pressed within a predetermined period of time; and selecting the signal pattern according to the detected repeating times.

The selecting of the signal pattern can be decided according to steps of: selecting the PRBS signal pattern when the repeating is one time within the predetermined period of time; selecting the K28.5 signal pattern when the repeating is two times within the predetermined period of time; selecting the HFTP signal pattern when the repeating is three times within the predetermined period of time; selecting the ComInit signal pattern when the repeating is four times within the predetermined period of time; and selecting the ComWake signal pattern when the repeating is five times within the predetermined period of time.

In an embodiment, the method can further have steps of: determining if the function key is pressed; and leaving the testing mode and returning to the ready state after the end of the testing mode or launching a reset or power down procedure when the function key is pressed. A LED can be further used for Indicating the status of the storage device when the storage device is in the testing mode. For example, it can be set to blink to indicate that the storage device is in the testing mode, and the selected signal pattern being transmitted can be indicated by number of blinks of the LED.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram illustrating the configuring of self-testing settings of an SATA device by utilizing a host computer in the prior art;

FIG. 2A is a block diagram illustrating the testing of an SATA device supporting BIST T Mode;

FIG. 2B is a block diagram illustrating the testing of an SATA device supporting BIST L Mode;

FIG. 3 is a system block diagram illustrating an STAT storage device with signal pattern generating function;

FIG. 4 is a flow chart illustrating a method for generating predetermined signal patterns according to an embodiment of the present invention;

FIG. 5A is a block diagram illustrating the testing of an SATA storage device with signal pattern generating function; and

FIG. 5B is a block diagram illustrating the testing of an SATA storage device supporting BIST L Mode while utilizing another SATA storage device with signal pattern generating function as a signal generator.

### DETAILED DESCRIPTION OF THE INVENTION

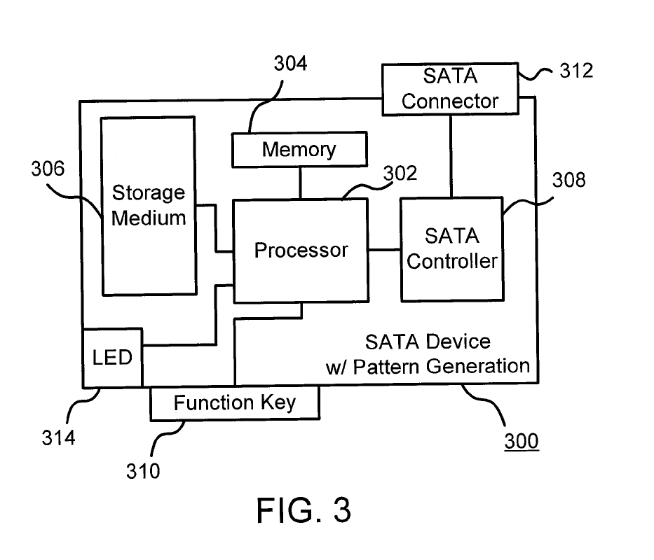

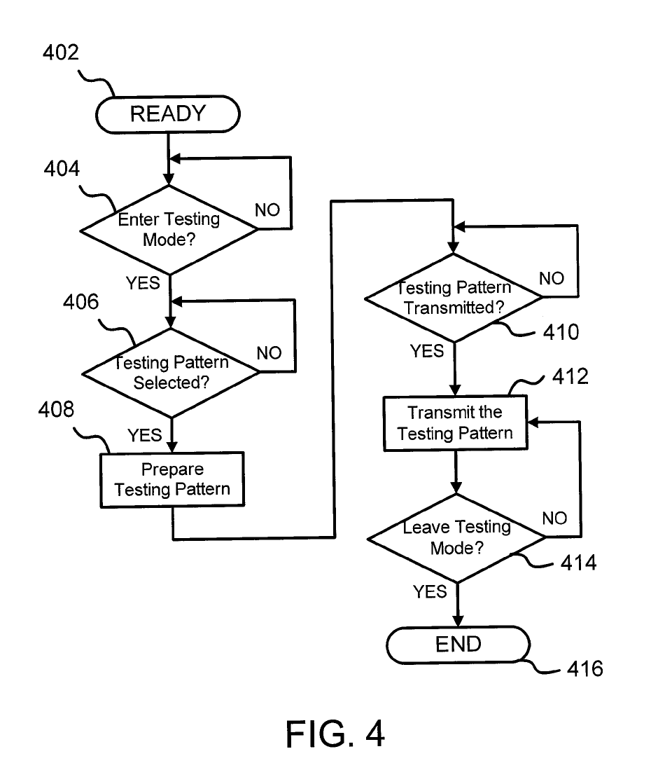

Refer to FIG. 3, which is a system block diagram illustrating an SATA storage device with signal pattern generating function, The STAT storage device including a processor 302, a memory 304, an interface controller 308 such as an SATA interface controller, and a storage medium 306 with information stored thereon. The processor can control the operation of the SATA device and access the information stored in the storage medium 306. The memory 304 is electrically connected to the processor 302 to store software or temporary data for the processor 304. The interface controller 308 is electrically connected to the processor 304 as well as an interface connector 312 such as an SATA connector for the processor 302 to exchange information with other devices or output a selected signal pattern through the interface connector 312. Moreover, the SATA device 300 can further has a function key 310 and a Light Emitted Diode (LED) 314. The function key 310 is electrically coupled to the processor 302 to control the SATA device to selectively operate in a testing mode, and the LED 314 can indicate the status of the SATA device 300.

Refer to FIG. 3, which is a flow chart illustrating a method for generating predetermined signal patterns according to an embodiment of the present invention. An STAT device, for example an SATA optical disc drive, enters a ready state after a start sequence triggered by powered on or reset operation as shown in step 402. For the ready state, the processor 302 of the SATA device executing a main loop program to continuously monitoring whether a task is to be handled. Then in step 404, by receiving a signal from the function key 310, the main loop can be triggered to enter a testing mode for the generation of testing signal patterns. The function key 310 can be a stand-alone function key or a key integrated with existing key originally for other functions. In an SATA optical disc drive, the eject key conventionally disposed on the front bezel can be assigned as the function key depicted in FIG. 3. For example, the processor 302 can enter the testing mode if the eject key has been pressed for more than a predetermined period of time (such as 5 seconds). Otherwise, the processor 302 remains in the ready state and keep monitoring whether to enter the testing mode. Meanwhile, the LED 314 can be set to blink to indicate that the SATA device has already enter the testing mode.

After the SATA device 300 is in the testing mode, in step 406 the testing signal pattern to be sent can be further selected. In a preferred embodiment, the processor can decide which testing signal pattern is selected by detecting the repeats that the function key 310 is pressed within a predetermined period of time. For example, within two seconds, if the function key 310 is pressed once, the PRBS signal pattern will be selected; if the function key 310 is pressed twice, the K28.5 signal pattern will be selected; and similarly the function key 310 is pressed three times for HFTP, four times for Cominit, five times for ComWake, and et al. Once the testing signal pattern is selected, the process moves into step 408 to prepare the selected testing signal pattern. LED 314 can also set to be turned on to help to indicate that the selected testing signal pattern is ready to be sent. Then in step 410, the SATA device 300 will decide whether to transmit the selected testing signal pattern. In the embodiment, the SATA optical disc drive will start to transmit the selected testing signal pattern while detecting the press of the ejection key.

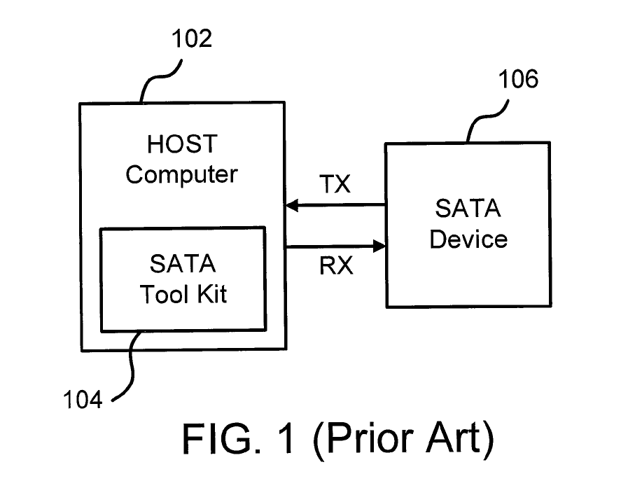

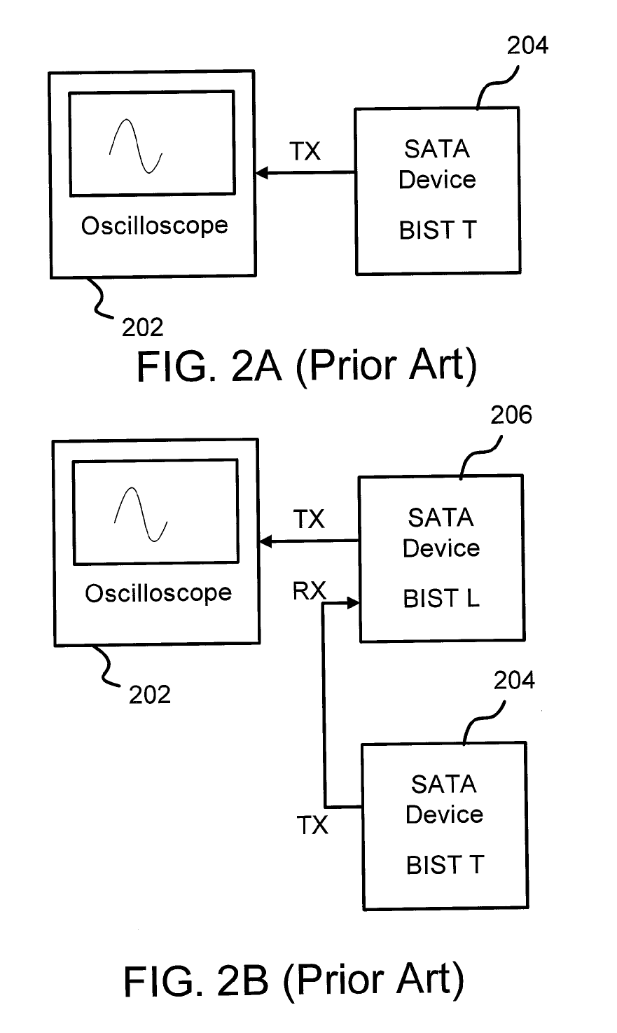

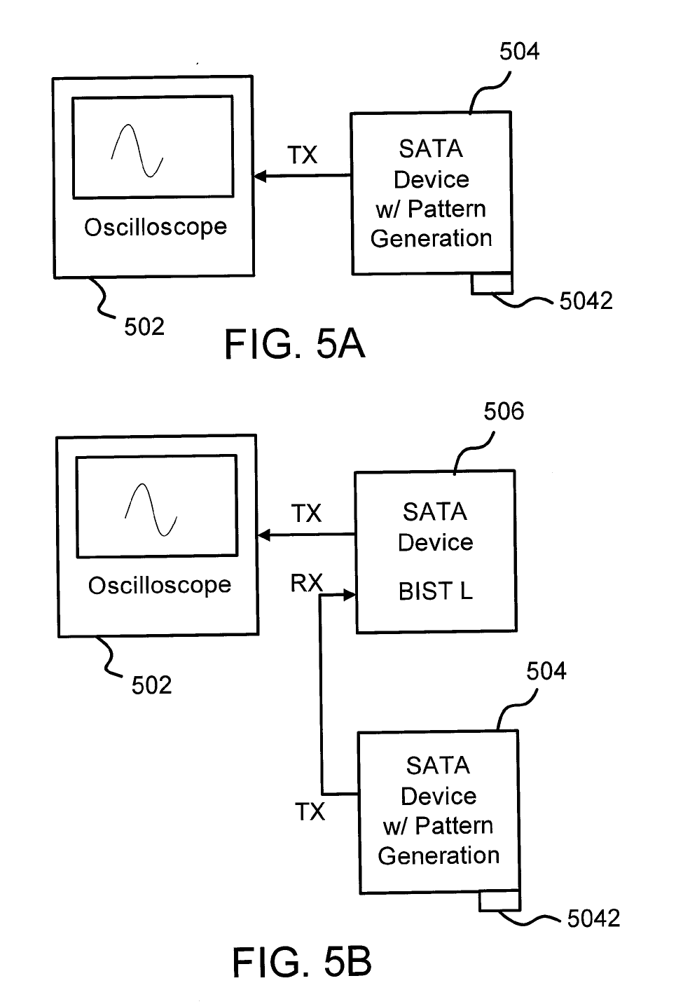

After the SATA device 300 decided to transmit the selected signal pattern, in step 412, the SATA device 300 performs the transmission and allows the LED 314 to indicate the signal pattern being transmitted by number of blinks. Then in the step 414, the SATA device 300 decides whether to leave the testing mode by any further trigger of the function key 314. In the embodiment, if the ejection key is pressed, the SATA optical disc drive will leave the testing mode and end the process as shown in step 416. The SATA device 300 can further return to the ready state after the end of the testing process or just launch a reset or power down procedure. Refer to FIGS. 5A, which is a block diagram illustrating the testing of an SATA storage device with signal pattern generating function. To examine the STAT device 504 with signal pattern generating function, it can be connected to an oscilloscope 502 directly, and the testing signal patterns can be selected via the function key 5042. Refer to FIGS. 5B, which is a block diagram illustrating the testing of an SATA storage device supporting BIST L Mode while utilizing another SATA storage device with signal pattern generating function as a signal generator. The SATA device 506 can also be connected to the oscilloscope 502 directly while the SATA device 504 with signal pattern generating function utilized as a function generator. Thus for testing an SATA device with all the signal patterns specified in corresponding industrial standard, no host computer 102 and the SATA tool kit 104 are required, and the procedure depicted in FIG. 1 and FIG. 2 has not to be repeated again and again. It can be accomplished by simply connect the SATA device with the testing instrument and control the test by the function key.

As previously mentioned, the function key of the SATA device can be a stand-alone switch or a key integrated with an existing one originally for other functions. It can also be implemented as one or more reserved connecting pins that can be connected to a switch while the SATA device is to be tested in the factory or the customer service center. Similarly, the LED for status indication can also be an additional LED for the generation of testing patterns only, a conventionally existing LED for multiple usages, or reserved pins on the PCB. Moreover, though the method and apparatus are explain by SATA, it can be used in transmission interfaces compliance with other industrial standards.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A device for generating signal patterns comprising:
a processor;
an interface controller electrically connected to the processor;
a function key electrically coupled to the processor to control the device to selectively operate in a testing mode; and
an interface connector electrically connected to the interface controller for the processor to output a selected signal pattern when the device is in the testing mode.

2. The device as in claim 1 wherein the interface controller is compliance with a Parallel Advanced Technology bus Attachment Interface industrial standard, and the interface connector is compliance with the Parallel Advanced Technology bus Attachment Interface industrial standard.

3. The device as in claim 1 wherein the interface controller is compliance with a Serial Advanced Technology bus Attachment Interface industrial standard, and the interface connector is compliance with the Serial Advanced Technology bus Attachment Interface industrial standard.

4. The device as in claim 3 wherein the device supports a “Built-In Self-Test The Far-End Retimed Loopback Mode” (BIST L Mode).

5. The device as in claim 3 wherein the device supports a “Built-In Self-Test The Far-End Transmit Mode” (BIST T Mode).

6. The device as in claim 1 wherein the function key is a key, a switch, or at least one connecting pin that can be connected to a switch.

7. The device as in claim 1 wherein the device is an optical disc drive, and the function key is integrated with ejection key of the optical disc drive.

8. A method for generating signal patterns in a storage device comprising steps of:
entering a testing mode;
selecting a signal pattern compliance with an industrial standard of transmission interface by a function key;
transmitting the selected signal pattern; and
ending the testing mode.

9. The method as in claim 8 wherein the industrial standard of transmission interface is a Parallel Advanced Technology bus Attachment Interface industrial standard.

10. The method as in claim 8 wherein the industrial standard of transmission interface is a Serial Advanced Technology bus Attachment Interface industrial standard.

11. The method as in claim 8 wherein the method further comprises steps of:
detecting the repeating times that the function key is pressed within a predetermined period of time; and
selecting the signal pattern according to the detected repeating times.

12. The method as in claim 10 wherein the method further comprises steps of:
selecting the PRBS signal pattern when the repeating is one time within the predetermined period of time;
selecting the K28.5 signal pattern when the repeating is two times within the predetermined period of time;
selecting the HFTP signal pattern when the repeating is three times within the predetermined period of time;
selecting the Cominit signal pattern when the repeating is four times within the predetermined period of time; and
selecting the ComWake signal pattern when the repeating is five times within the predetermined period of time.

13. The method as in claim 8 wherein the method further comprises steps of:
determining if the function key is pressed; and
leaving the testing mode and returning to the ready state after the end of the testing mode or launching a reset or power down procedure when the function key is pressed.

14. The method as in claim 8 wherein the method further comprises steps of:
Indicating the status of the storage device by a LED when the storage device is in the testing mode.

15. The method as in claim 14 wherein the method further comprises steps of:
setting the LED to blink to indicate that the storage device is in the testing mode; and
indicating the selected signal pattern being transmitted by number of blinks of the LED.

16. The method as in claim 8 wherein the function key is a key, a switch, or at least one connecting pin that can be connected to a switch.

17. The method as in claim 8 wherein the device is an optical disc drive, and the function key is integrated with ejection key of the optical disc drive.
